(19) United States
(12) Patent Application Publication
(10) Pub. No.: US 2020/0060420 A1
(43) Pub. Date: Feb. 27, 2020

(54) ADJUSTABLE FOLDING STAND FOR A PORTABLE ELECTRONIC DEVICE

(71) Applicant: DesignNest Inc., Costa Mesa, CA (US)

(72) Inventors: Weijie Hu, Costa Mesa, CA (US); Ben Tian Lin, Costa Mesa, CA (US)

(21) Appl. No.: 16/552,831

(22) Filed: Aug. 27, 2019

(30) Foreign Application Priority Data
Aug. 27, 2018 (CN) CN201821389088.0
Dec. 27, 2018 (CN) CN201822224087.7

(51) Int. Cl. A47B 23/04; F16M 13/00

(52) U.S. Cl. CPC A47B 23/043; A47B 2023/049; F16M 13/005

(57) ABSTRACT

An adjustable folding stand for supporting an electronic device is described herein. The stand has a device supporting platform, base platform, foldable connector disposed between and pivotably connected to each of the device supporting platform and the base platform, first supporting arm on one side of the foldable connector, and second supporting arm on an opposite side of the foldable connector. The first supporting arm and the second supporting arm are each pivotably connected to the device supporting platform and to the base platform. The folding stand is attached to the electronic device such that the device supporting platform is coupled to an underside surface of the electronic device. The stand is pivotably moveable to achieve multiple positions including a flattened configuration, a first folded configuration, and a second folded configuration for supporting the electronic device in upright orientations.

### CROSS-REFERENCES TO RELATED APPLICATIONS

This application claims benefit of Chinese Utility Model Application No. 201821389088.0 filed Aug. 27, 2018 and Chinese Utility Model Application No. 201822224087.7 filed Dec. 27, 2018, the specification(s) of which is/are incorporated herein in their entirety by reference.

### FIELD OF THE INVENTION

The present invention relates to folding stands, namely, to a folding stand that allows for angle adjustment of a portable electronic device, such as a laptop or tablet.

### BACKGROUND OF THE INVENTION

Portable electronic devices, such as laptops, tablets, and smartphones, are popular devices that have become common place in today's society. In addition to entertainment and communication, people can use portable electronic devices for work or education purposes. For example, workers use their laptops for business outside of an office or students use their devices to complete their school work outside of the classroom or home. When using the devices in public locations, such as a coffee shop, restaurant, library or other building, said locations typically do not provide ergonomic work spaces for a user to comfortably work for hours at a time. There are many existing stands for portable devices; however, these stands tend to be large, bulky, and/or complicated to assemble. Furthermore, people prefer to reduce their baggage load as much as possible when travelling or in transit, therefore heavy or bulky equipment may not be suitable for working remotely. Hence, there is a need for a portable electronic device stand that is compact, easy to use, and can provide proper ergonomics.

### BRIEF SUMMARY OF THE INVENTION

It is an objective of the present invention to provide devices and methods of supporting a portable electronic device that allow for adjustment of a display angle, as specified in the independent claims. Embodiments of the invention are given in the dependent claims. Embodiments of the present invention can be freely combined with each other if they are not mutually exclusive.

In some aspects, the present invention features an adjustable folding stand for supporting an electronic device. The folding stand may comprise a device supporting platform, a base platform, a foldable connector comprising a first panel and a second panel pivotably connected to each other via a first hinge, a first supporting arm disposed on one side of the foldable connector, and a second supporting arm disposed on another side of the foldable connector opposite of the first supporting arm. In some embodiments, the first panel is pivotably connected to the device supporting platform via a second hinge and the second panel is pivotably connected to the base platform via a third hinge such that the first hinge is disposed between the second hinge and the third hinge, and the foldable connector is disposed between the device supporting platform and the base platform. In other embodiments, the first supporting arm is pivotably connected to the device supporting platform via a fourth hinge and to the base platform via a fifth hinge such that the first supporting arm is disposed between the device supporting platform and the base platform. The second supporting arm is pivotably connected to the device supporting platform via a sixth hinge and pivotably connected to the base platform via a seventh hinge such that the second supporting arm is disposed between the device supporting platform and the base platform. Preferably, the first supporting arm and the second supporting arm are detached from the foldable connector. The folding stand can be attached to the electronic device such that the device supporting platform is coupled to an underside surface of the electronic device.

In some embodiments, the components of the adjustable folding stand can be pivotably moveable about the hinges to achieve multiple positions. These positions include at least: i) a flattened configuration where the device supporting platform, the base platform, the foldable connector, the first supporting arm, and the second supporting arm are co-planar; ii) a first folded configuration for supporting the electronic device in a first upright orientation having a first angle (θ1) between the base platform and the underside surface of the electronic device; and iii) a second folded configuration for supporting the electronic device in a second upright orientation having a second angle (θ2) between the base platform and the underside surface of the electronic device, where the angle θ2 is less than the angle θ1.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1A is a back view of an adjustable folding stand of the present invention.

FIG. 1B shows a perspective view of the folding stand in a flattened configuration and disposed on a back of an electronic device.

FIGS. 2A-2B show the folding stand in a first folded configuration.

FIGS. 3A-3C show the folding stand in a second folded configuration.

FIG. 4A is a front view of the folding stand with a device backing attached thereto.

FIG. 4B is a perspective view of the folding stand with the device backing.

FIG. 5 is a top view of the folding stand in the first folded configuration.

FIG. 6 is a bottom view of the folding stand in the first folded configuration.

FIG. 7 is a front view of the folding stand in the first folded configuration.

FIG. 8 is a back view of the folding stand in the second folded configuration.

FIG. 9 is a top view of the folding stand in the second folded configuration.

FIG. 10 is a bottom view of the folding stand in the second folded configuration.

FIG. 11 is a front view of the folding stand in the second folded configuration.

FIG. 12 is a back view of the folding stand in the second folded configuration.

FIG. 13 shows a top perspective view of the folding stand in the first folded configuration.

FIG. 14 shows a top perspective view of the folding stand in the second folded configuration

FIG. 15 shows a bottom perspective view of the folding stand in the first folded configuration.

FIG. 16 shows a bottom perspective view of the folding stand in the second folded configuration.

FIG. 17 is an alternative embodiment of the adjustable folding stand.

FIG. 18 shows the embodiment of the folding stand in FIG. 17 disposed on the back of an electronic device in a folded configuration.

FIG. 19 shows the embodiment of the folding stand in FIG. 17 in another folded configuration.

FIG. 20 shows the embodiment of the folding stand in FIG. 17 in yet another folded configuration.

FIG. 21 shows another alternative embodiment of the adjustable folding stand.

FIG. 22 shows the embodiment of the folding stand in FIG. 21 disposed on the back of an electronic device in a folded configuration.

### DETAILED DESCRIPTION OF THE INVENTION

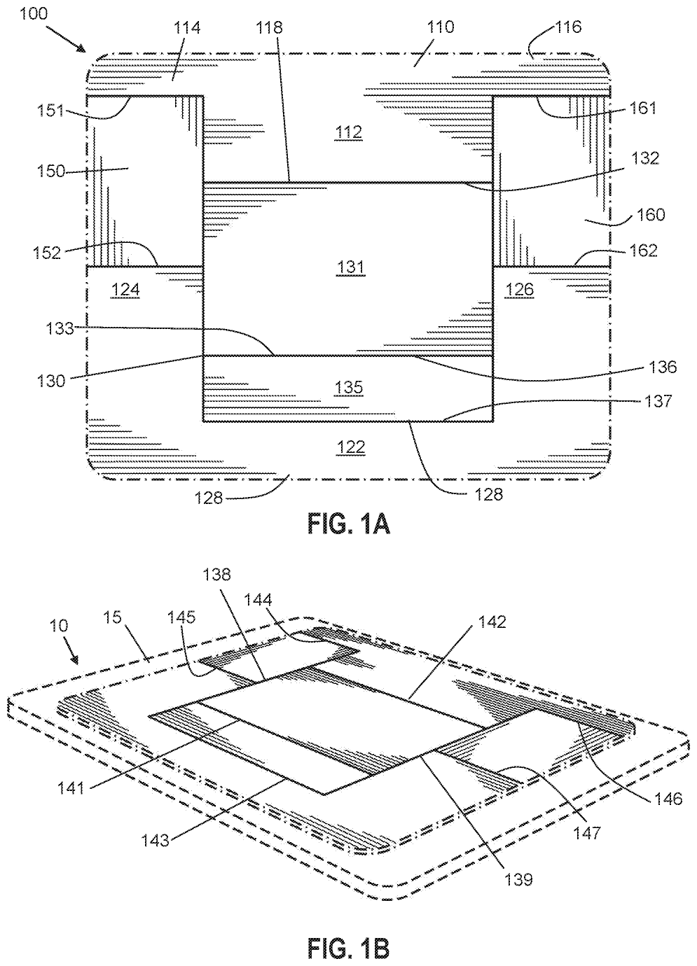

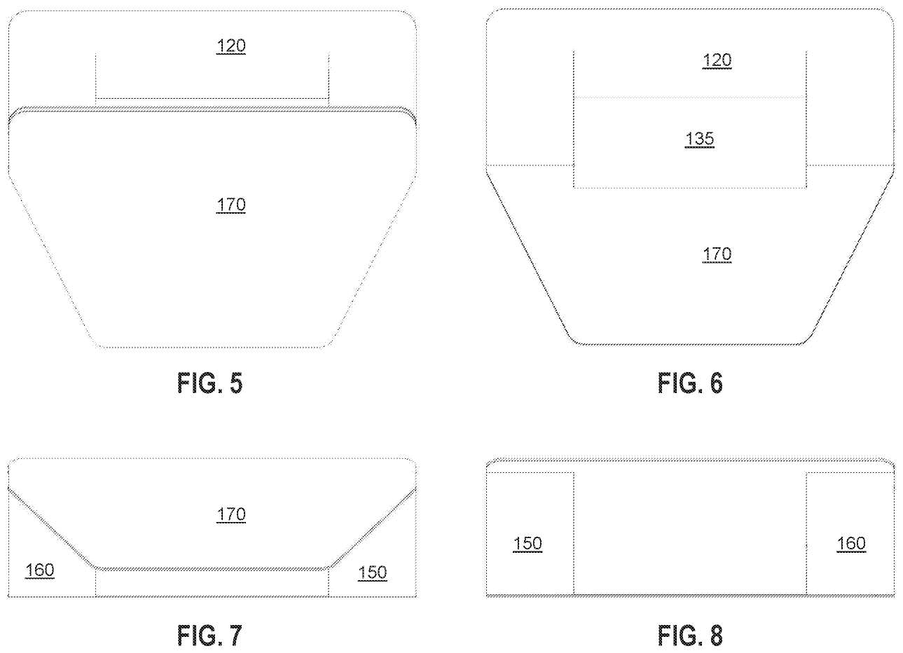

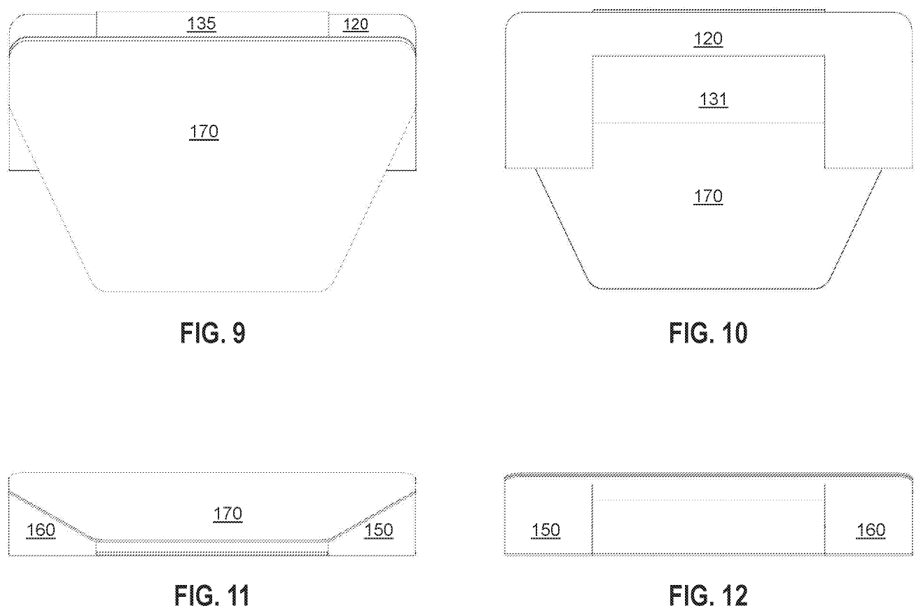

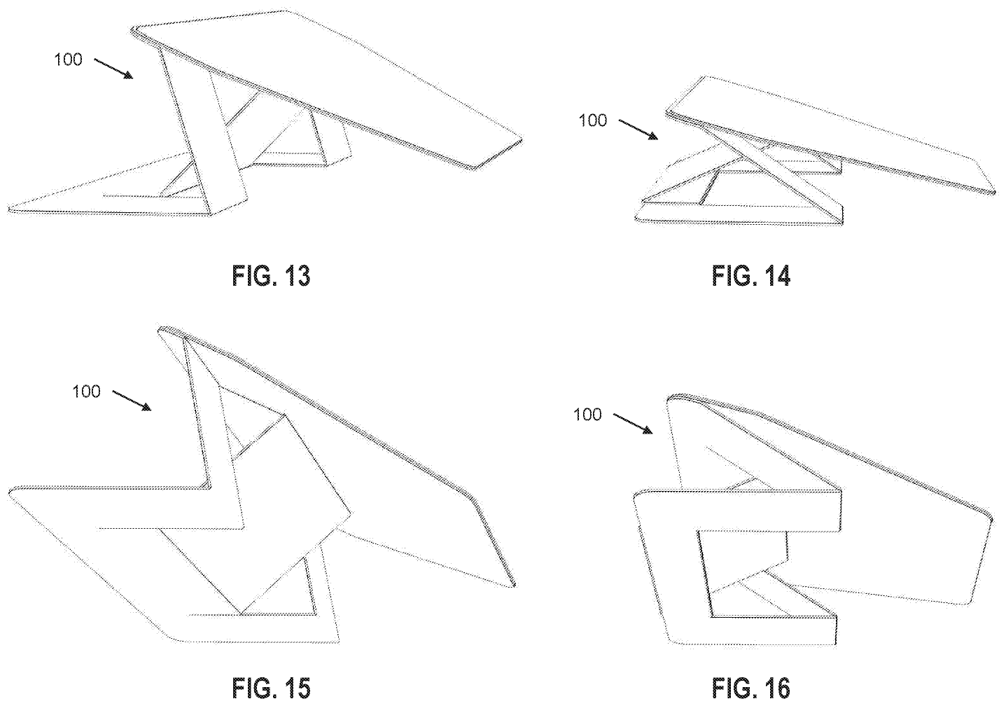

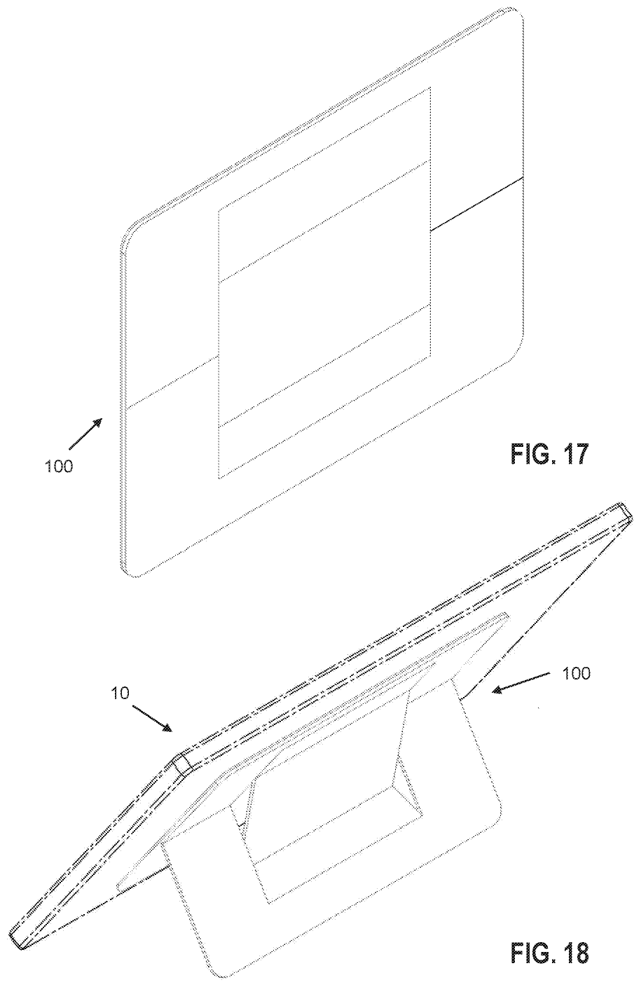

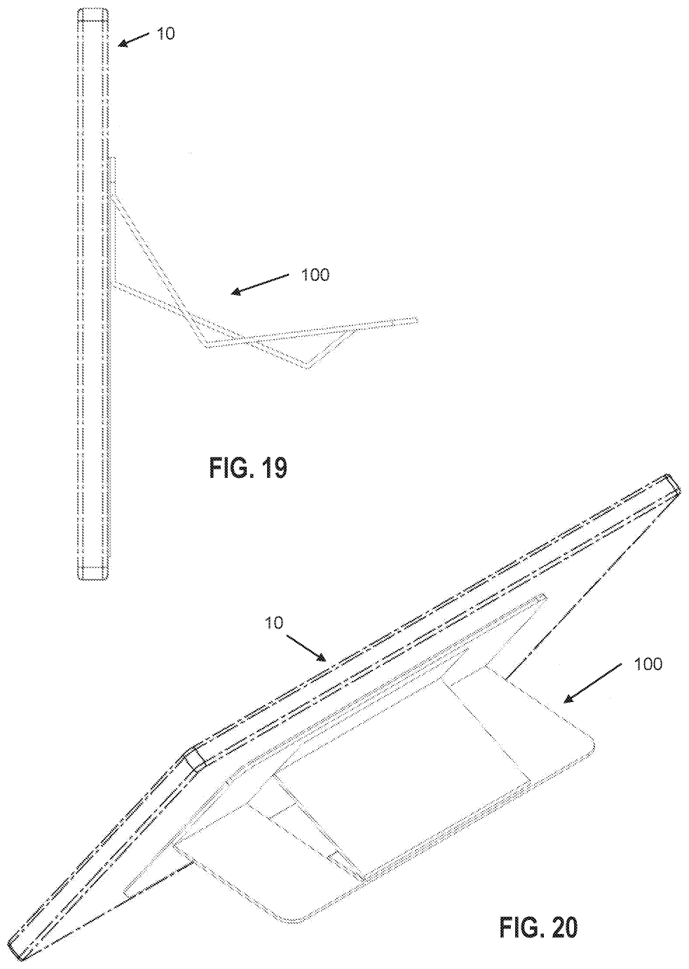

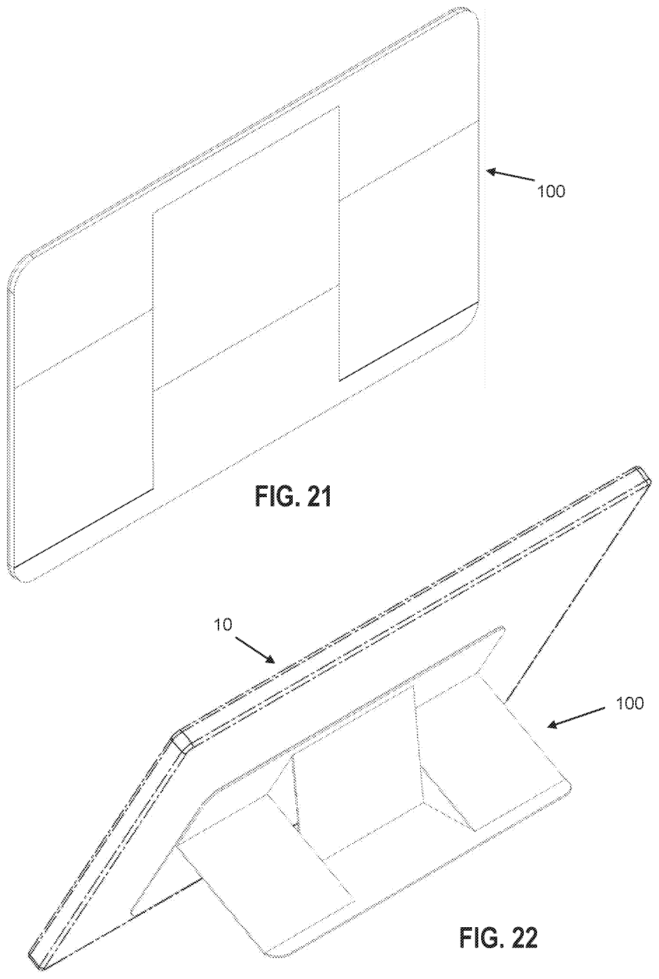

Referring now to FIGS. 1A-16, the present invention features an adjustable folding stand (100) for supporting an electronic device (10). The folding stand (100) may comprise a device supporting platform (110), a base platform (120), a foldable connector (130) comprising a first panel (131) and a second panel (135) pivotably connected to each other via a first hinge (141), a first supporting arm (150) disposed on one side (138) of the foldable connector, and a second supporting arm (160) disposed on another side (139) of the foldable connector opposite of the first supporting arm (150). In some embodiments, the first panel (131) is pivotably connected to the device supporting platform (110) via a second hinge (142) and the second panel (135) is pivotably connected to the base platform (120) via a third hinge (143) such that the first hinge (141) is disposed between the second hinge (142) and the third hinge (143), and the foldable connector (130) is disposed between the device supporting platform (110) and the base platform (120). In other embodiments, the first supporting arm (150) is pivotably connected to the device supporting platform (110) via a fourth hinge (144) and to the base platform (120) via a fifth hinge (145) such that the first supporting arm (150) is disposed between the device supporting platform (110) and the base platform (120). The second supporting arm (160) is pivotably connected to the device supporting platform (110) via a sixth hinge (146) and pivotably connected to the base platform (120) via a seventh hinge (147) such that the second supporting arm (160) is disposed between the device supporting platform (110) and the base platform (120). In a preferred embodiment, the first supporting arm (150) and the second supporting arm (160) are detached from the foldable connector (130).

As used herein, the term “hinge” refers to a movable joint that rotates about an axis. An axis of rotation or rotational axis refers to an imaginary straight line through fixed points of a rotating rigid body around which all other points of the body move in circles. In some embodiments, a rotational axis of one hinge is parallel to a rotational axis of another hinge such that all the rotational axes are parallel to each other. As shown in FIG. 1B, the fourth and sixth hinges are co-axial. Also, the fifth and seventh hinges are co-axial.

In some embodiments, the folding stand (100) is configured to be attached to the electronic device (10) such that the device supporting platform (110) is coupled to an underside surface (15) of the electronic device. Examples of the electronic device (10) include, but are not limited to tablets such as an IPAD or KINDLE, smartphones, laptops, and netbooks. In one embodiment, the device supporting platform (110) may be coupled to a bottom surface or base of a laptop or to a back of a tablet or smartphone.

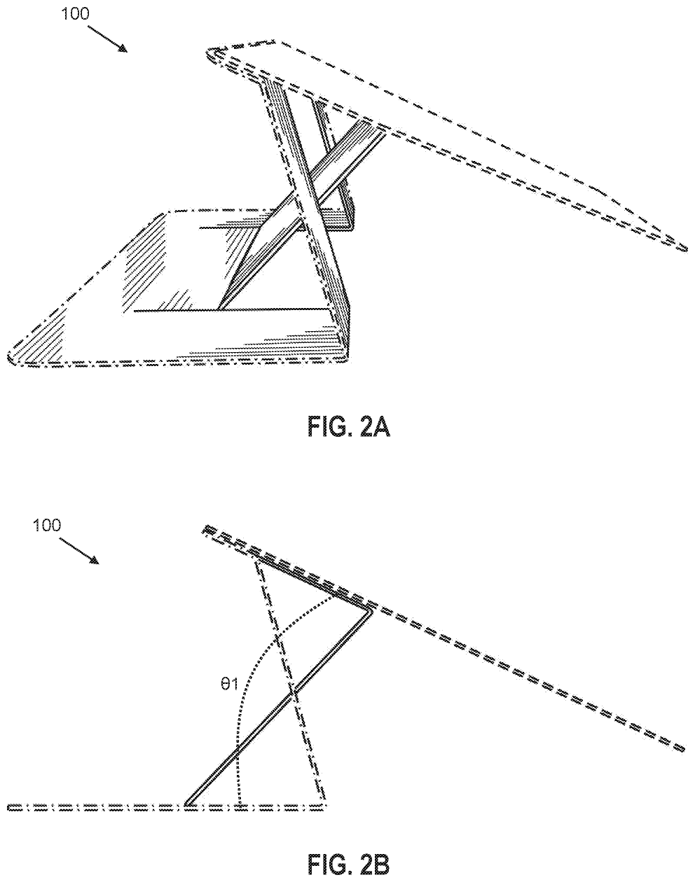

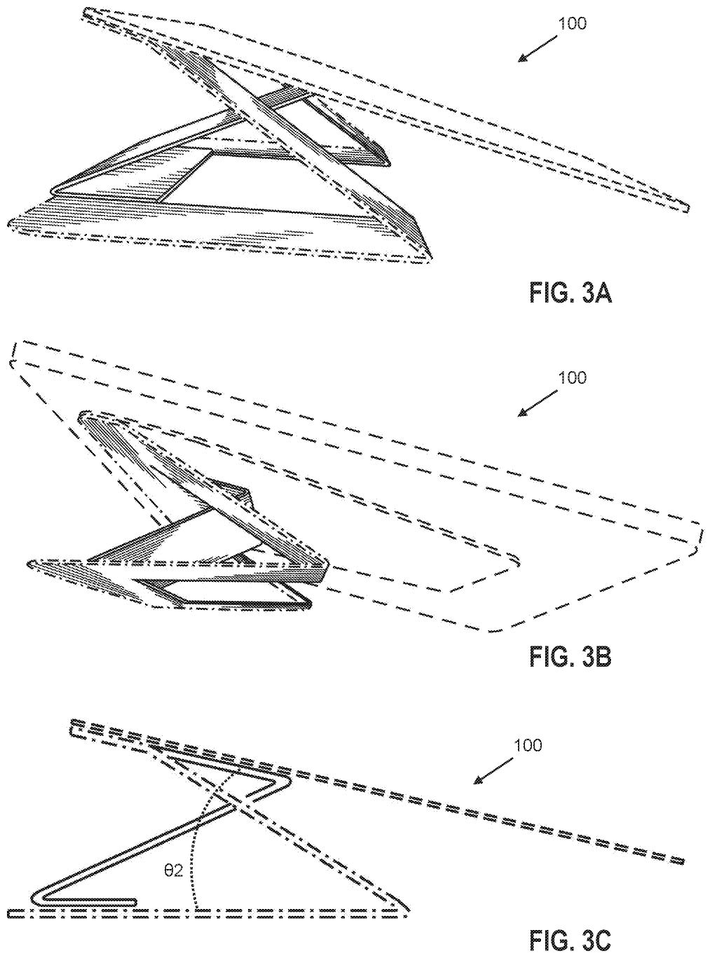

In preferred embodiments, the device supporting platform (110), the base platform (120), the foldable connector (130), the first supporting arm (150), and the second supporting arm (160) can be pivotably moveable to certain positions. These positions include i) a flattened configuration where the device supporting platform (110), the base platform (120), the foldable connector (130), the first supporting arm (150), and the second supporting arm (160) are co-planar as shown in FIGS. 1A-1B; ii) a first folded configuration for supporting the electronic device (10) in a first upright orientation having a first angle (θ1) between the base platform (120) and the underside surface (15) of the electronic device as shown in FIGS. 2A-2B; and iii) a second folded configuration for supporting the electronic device (10) in a second upright orientation having a second angle (θ2) between the base platform (120) and the underside surface (15) of the electronic device as shown in FIGS. 3A-3C. Comparing FIG. 2B to 3C, the angle θ2 is less than the angle θ1.

According to other embodiments, the adjustable folding stand (100) may comprise a T-shaped device supporting platform (110) comprising a platform panel (112) with a first panel tab (114) extending laterally and perpendicularly from one side at one end of the panel and a second panel tab (116) extending laterally and perpendicularly from an opposing side at the same end of the platform panel, a U-shaped base platform (120) comprising a straight bar (122) with a first bar tab (124) extending laterally and perpendicularly from one end at one side of the bar and a second bar tab (126) extending laterally and perpendicularly from an opposing end at the same side of the straight bar, a foldable connector (130) comprising a first panel (131) and a second panel (135), a first supporting arm (150) disposed on one side (138) of the foldable connector between the device supporting platform (110) and the base platform (120), and a second supporting arm (160) disposed on another side (139) of the foldable connector opposite of the first supporting arm (150) and between the device supporting platform (110) and the base platform (120). The folding stand (100) is configured to attach to the electronic device (10) such that the device supporting platform (110) is coupled to an underside surface (15) of the electronic device.

Referring to FIG. 1A, in one embodiment, a second side edge (133) of the first panel is pivotably connected to a first side edge (136) of the second panel via a first hinge (141). A first side edge (132) of the first panel is pivotably connected to a panel side edge (118) of the platform panel via a second hinge (142). In some embodiments, a second side edge (137) of the second panel is pivotably connected to a bar side edge (128) of the straight bar via a third hinge (143) such that the first hinge (141) is disposed between the second hinge (142) and the third hinge (143), and the foldable connector (130) is disposed between the device supporting platform (110) and the base platform (120). In some embodiments, a first end (151) of the first supporting arm is pivotably connected to the first panel tab (114) of the device supporting platform via a fourth hinge (144), and a second end (152) of the first supporting arm is pivotably connected to the first bar tab (124) of the base platform via a fifth hinge (145). In other embodiments, a first end (161) of the second supporting arm is pivotably connected to the second panel tab (116) of the device supporting platform (110) via a sixth hinge (146), and a second end (162) of the second supporting arm is pivotably connected to the second bar tab (126) of the base platform via a seventh hinge (147). Preferably, the first supporting arm (150) and the second supporting arm (160) are detached from the foldable connector (130) such that a first slit is formed between the combined platform panel/foldable connector and the combined first supporting arm/first panel tab. A second slit is formed between the combined platform panel/foldable connector and the combined second supporting arm/second panel tab.

In some preferred embodiments, a rotational axis of one hinge is parallel to a rotational axis of another hinge such that all the rotational axes are parallel to each other. In other preferred embodiments, the fourth and sixth hinges are co-axial, and the fifth and seventh hinges are co-axial.

In one embodiment, when the folding stand (100) is in a flattened configuration as shown in FIGS. 1A-1B, the device supporting platform (110), the base platform (120), the foldable connector (130), the first supporting arm (150), and the second supporting arm (160) are co-planar. Also, the rotational axis of the second hinge is positioned between the shared rotational axis of the fourth and sixth hinges and the shared rotational axis of the fifth and seventh hinges. Furthermore, the rotational axis of the first hinge is positioned between the shared rotational axis of the fifth and seventh hinges and the rotational axis of the third hinge.

In another embodiment, when the folding stand (100) is in a first folded configuration as shown in FIGS. 2A-2B, the base platform (120) and the second panel (135) of the foldable connector remain co-planar while the device supporting platform (110), the first panel (131) of the foldable connector, the first supporting arm (150), and the second supporting arm (160) are pivoted towards the base platform (120). In yet another embodiment, when the folding stand (100) is in a second folded configuration as shown in FIGS. 3A-3C, the second panel (135) of the foldable connector is flipped and stacked over or on top of the straight bar (122) of the base platform while the device supporting platform (110), the first panel (131) of the foldable connector, the first supporting arm (150), and the second supporting arm (160) are pivoted towards the base platform (120). Without wishing to be bound to a particular mechanism, the first folded configuration has a first angle (θ1) between the base platform (120) and the device supporting platform (110). The second folded configuration has a second angle (θ2) between the base platform (120) and the device supporting platform (110) that is less than first angle (θ1).

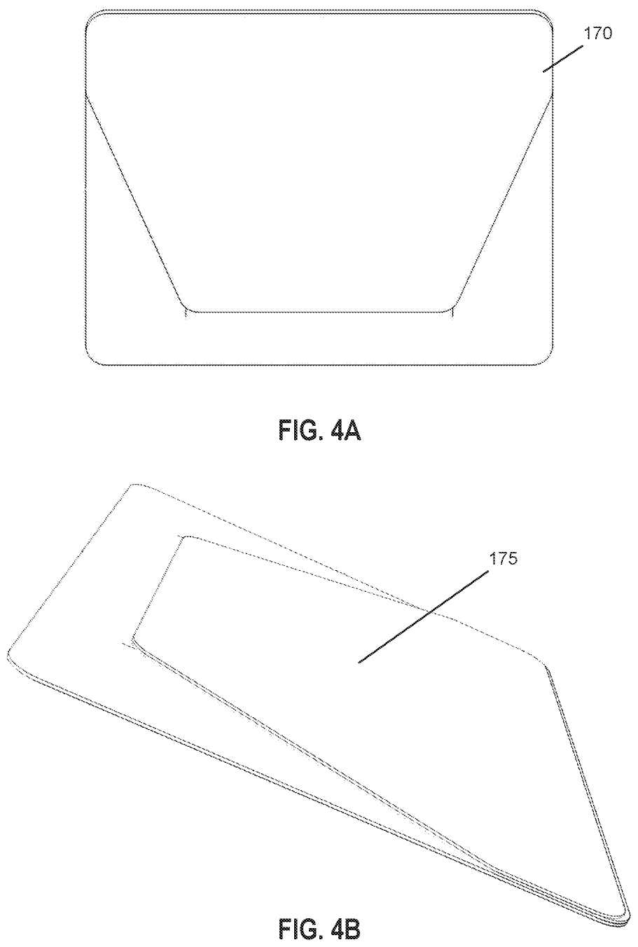

Referring now to FIGS. 4A-4B, in some embodiments, the folding stand (100) may further comprise a device backing (170) attached to the device supporting platform (110). The device backing (170) configured to attach the folding stand (100) to the underside surface (15) of the electronic device. In some embodiments, the device backing (170) has an adhesive surface (175) for adhering to the underside surface (15) of the electronic device. In some embodiments, the adhesive surface (175) of the device backing is capable of being attached, removed, and re-attached to the electronic device. In other embodiments, the device backing may comprise a vinyl material or layer utilizing re-usable, non-adhesive static cling for adherence. For example, if the folding stand (100) is improperly positioned of the device or if the folding stand (100) is to be used on another device, the the folding stand (100) can be removed, repositioned, and re-attached to an electronic device. Preferably, the the folding stand (100) will maintain its stickiness.

In some embodiments, the device supporting platform (110), the base platform (120), the foldable connector (130), the first supporting arm (150), and the second supporting arm (160) are each constructed from a planar rigid material. Non-limiting examples of the planar rigid material include a metal or plastic material such as a moldable thermoplastic. Preferably, the rigid material is sufficiently strong such the stand (100) can support the weight of the electronic device. For instance, the stand (100) can support an electronic device weighing about ½ lb. to about 20 lbs.

In other embodiments, the hinges (141-147) may comprise a flexible material or hinged plates. Non-limiting examples of the flexible material include a fabric, leather, silicone, an elastomer such as rubber, or plastic material such as polyester, PVS, or polyurethane. As a non-limiting example, the device supporting platform (110), the base platform (120), the foldable connector (130), the first supporting arm (150), and the second supporting arm (160) may each be constructed from a planar rigid material and connected to each other by a continuous flexible material covering the planar rigid materials. Thus, the flexible material forms the hinges (141-147).

In some embodiments, the panels of the foldable connector and the supporting arms are rectangular in shape. However, they may also be cut to have patterned edges or surfaces or have a non-rectangular shape while still maintaining structural integrity of the stand, particularly when in the folded configurations. In some embodiments, the individual components of the stand can collectively form a shape such that the foldable stand has an overall appearance of a rectangle as shown in FIG. 1A, an oval, or circle, etc. The broken line boundaries shown in FIGS. 1A-1B demonstrate that the folding stand is not limited to a rectangular shape. Without wishing to limit the present invention, the arrangement of the individual components and hinges is important for allowing the stand to be flat during transport or when not in use, and to move between the first and second upright configurations when in use. This allows a user to choose a specific orientation that provides a desired display angle and/or ergonomics. None of the presently known prior references or work has this unique inventive technical feature of the present invention.

Since adjustable folding stands (100) have been described herein, methods of utilizing said folding stands (100) are desired. According to some embodiments, the present invention provides a method of positioning an electronic device (10) in an upright orientation. The method may comprise providing any one of the adjustable folding stands (100) described herein, attaching the device supporting platform (110) to the underside surface (15) of the electronic device, and pivotably moving the folding stand (100) into one of two positions based on a desired angle in the upright orientation. These two positions are i) the first folded configuration for supporting the electronic device (10) in the first upright orientation having a first angle (θ1) between the base platform (120) and the underside surface (15) of the electronic device, or ii) the second folded configuration for supporting the electronic device (10) in a second upright orientation having a second angle (θ2) between the base platform (120) and the underside surface (15) of the electronic device, where 82 is less than 81. In some embodiments, the step of attaching the device supporting platform (110) to the underside surface (15) of the electronic device comprises adhering a device backing (170), which is fixedly attached to the device supporting platform (110), to the underside surface (15) of the electronic device. In preferred embodiments, the methods of the present invention may be used to prop up electronic devices (10) such as tablets, smartphones, or laptops.

As used herein, the term “about” refers to plus or minus 10% of the referenced number.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. An adjustable folding stand (100) for supporting an electronic device (10), said folding stand (100) comprising:
a. a device supporting platform (110);
b. a base platform (120);
c. a foldable connector (130) comprising a first panel (131) and a second panel (135) pivotably connected to each other via a first hinge (141),
wherein the first panel (131) is pivotably connected to the device supporting platform (110) via a second hinge (142) and the second panel (135) is pivotably connected to the base platform (120) via a third hinge (143) such that the first hinge (141) is disposed between the second hinge (142) and the third hinge (143), and the foldable connector (130) is disposed between the device supporting platform (110) and the base platform (120);
d. a first supporting arm (150) disposed on one side (138) of the foldable connector, wherein the first supporting arm (150) is pivotably connected to the device supporting platform (110) via a fourth hinge (144) and to the base platform (120) via a fifth hinge (145) such that the first supporting arm (150) is disposed between the device supporting platform (110) and the base platform (120); and
e. a second supporting arm (160) disposed on another side (139) of the foldable connector opposite of the first supporting arm (150), wherein the second supporting arm (160) is pivotably connected to the device supporting platform (110) via a sixth hinge (146) and pivotably connected to the base platform (120) via a seventh hinge (147) such that the second supporting arm (160) is disposed between the device supporting platform (110) and the base platform (120), wherein the first supporting arm (150) and the second supporting arm (160) are detached from the foldable connector (130);
wherein a rotational axis of one hinge is parallel to a rotational axis of another hinge such that all the rotational axes are parallel to each other, wherein the fourth and sixth hinges are co-axial, wherein the fifth and seventh hinges are co-axial,
wherein the folding stand (100) is configured to be attached to the electronic device (10) such that the device supporting platform (110) is coupled to an underside surface (15) of the electronic device, wherein the device supporting platform (110), the base platform (120), the foldable connector (130), the first supporting arm (150), and the second supporting arm (160) are pivotably moveable to positions of at least:
i. a flattened configuration where the device supporting platform (110), the base platform (120), the foldable connector (130), the first supporting arm (150), and the second supporting arm (160) are co-planar;
ii. a first folded configuration for supporting the electronic device (10) in a first upright orientation having a first angle (θ1) between the base platform (120) and the underside surface (15) of the electronic device; and
iii. a second folded configuration for supporting the electronic device (10) in a second upright orientation having a second angle (θ2) between the base platform (120) and the underside surface (15) of the electronic device, wherein 82 is less than 81.

2. The folding stand (100) of claim 1 further comprising a device backing (170) attached to the device supporting platform (110), the device backing (170) configured to attach the folding stand (100) to the underside surface (15) of the electronic device.

3. The folding stand (100) of claim 2, wherein the device backing (170) has an adhesive surface (175) for adhering to the underside surface (15) of the electronic device.

4. The folding stand (100) of claim 3, wherein the adhesive surface (175) of the device backing is capable of being attached, removed, and re-attached to the electronic device.

5. The folding stand (100) of claim 1, wherein the device supporting platform (110), the base platform (120), the foldable connector (130), the first supporting arm (150), and the second supporting arm (160) are each constructed from a planar rigid material.

6. The folding stand (100) of claim 1, wherein the hinges (141-147) comprise hinged plates or a flexible material.

7. The folding stand (100) of claim 1, wherein the device supporting platform (110), the base platform (120), the foldable connector (130), the first supporting arm (150), and the second supporting arm (160) are each constructed from a planar rigid material, wherein the device supporting platform (110), the base platform (120), the foldable connector (130), the first supporting arm (150), and the second supporting arm (160) are connected to each other by a continuous flexible material covering the planar rigid materials, wherein the flexible material forms the hinges (141-147).

8. A method of positioning an electronic device (10) in an upright orientation, comprising:
a. providing the adjustable folding stand (100) of claim 1;
b. attaching the device supporting platform (110) to the underside surface (15) of the electronic device; and
c. pivotably moving the folding stand (100) into one of two positions based on a desired angle in the upright orientation:
i. the first folded configuration for supporting the electronic device (10) in the first upright orientation having a first angle (θ1) between the base platform (120) and the underside surface (15) of the electronic device; or
ii. the second folded configuration for supporting the electronic device (10) in a second upright orientation having a second angle (θ2) between the base platform (120) and the underside surface (15) of the electronic device, wherein θ2 is less than θ1.

9. The method of claim 8, wherein the electronic device (10) is a tablet or laptop.

10. An adjustable folding stand (100) for supporting an electronic device (10), said folding stand (100) comprising:
a. a T-shaped device supporting platform (110) comprising a platform panel (112) with a first panel tab (114) extending laterally and perpendicularly from one side at one end of the panel and a second panel tab (116) extending laterally and perpendicularly from an opposing side at the same end of the platform panel;
b. a U-shaped base platform (120) comprising a straight bar (122) with a first bar tab (124) extending laterally and perpendicularly from one end at one side of the bar and a second bar tab (126) extending laterally and perpendicularly from an opposing end at the same side of the straight bar;
c. a foldable connector (130) comprising a first panel (131) and a second panel (135), wherein a second side edge (133) of the first panel is pivotably connected to a first side edge (136) of the second panel via a first hinge (141),
wherein a first side edge (132) of the first panel is pivotably connected to a panel side edge (118) of the platform panel via a second hinge (142), wherein a second side edge (137) of the second panel is pivotably connected to a bar side edge (128) of the straight bar via a third hinge (143) such that the first hinge (141) is disposed between the second hinge (142) and the third hinge (143), and the foldable connector (130) is disposed between the device supporting platform (110) and the base platform (120);
d. a first supporting arm (150) disposed on one side (138) of the foldable connector between the device supporting platform (110) and the base platform (120), wherein a first end (151) of the first supporting arm is pivotably connected to the first panel tab (114) of the device supporting platform via a fourth hinge (144), wherein a second end (152) of the first supporting arm is pivotably connected to the first bar tab (124) of the base platform via a fifth hinge (145); and
e. a second supporting arm (160) disposed on another side (139) of the foldable connector opposite of the first supporting arm (150) and between the device supporting platform (110) and the base platform (120), wherein a first end (161) of the second supporting arm is pivotably connected to the second panel tab (116) of the device supporting platform (110) via a sixth hinge (146), wherein a second end (162) of the second supporting arm is pivotably connected to the second bar tab (126) of the base platform via a seventh hinge (147), wherein the first supporting arm (150) and the second supporting arm (160) are detached from the foldable connector (130);
wherein a rotational axis of one hinge is parallel to a rotational axis of another hinge such that all the rotational axes are parallel to each other, wherein the fourth and sixth hinges are co-axial, wherein the fifth and seventh hinges are co-axial,
wherein the folding stand (100) is configured to be attached to the electronic device (10) such that the device supporting platform (110) is coupled to an underside surface (15) of the electronic device,
wherein when the folding stand (100) is in a flattened configuration, the device supporting platform (110), the base platform (120), the foldable connector (130), the first supporting arm (150), and the second supporting arm (160) are co-planar, the rotational axis of the second hinge is positioned between the shared rotational axis of the fourth and sixth hinges and the shared rotational axis of the fifth and seventh hinges, and the rotational axis of the first hinge is positioned between the shared rotational axis of the fifth and seventh hinges and the rotational axis of the third hinge,
wherein when the folding stand (100) is in a first folded configuration, the base platform (120) and the second panel (135) of the foldable connector remain co-planar while the device supporting platform (110), the first panel (131) of the foldable connector, the first supporting arm (150), and the second supporting arm (160) are pivoted towards the base platform (120),
wherein when the folding stand (100) is in a second folded configuration, the second panel (135) of the foldable connector is flipped and stacked on top of the straight bar (122) of the base platform while the device supporting platform (110), the first panel (131) of the foldable connector, the first supporting arm (150), and the second supporting arm (160) are pivoted towards the base platform (120),
wherein the first folded configuration has a first angle (θ1) between the base platform (120) and the device supporting platform (110), wherein the second folded configuration has a second angle (θ2) between the base platform (120) and the device supporting platform (110) that is less than first angle (θ1).

11. The folding stand (100) of claim 10 further comprising a device backing (170) attached to the device supporting platform (110), the device backing (170) configured to attach the folding stand (100) to the underside surface (15) of the electronic device.

12. The folding stand (100) of claim 11, wherein the device backing (170) has an adhesive surface (175) for adhering to the underside surface (15) of the electronic device, wherein the adhesive surface (175) of the device backing is capable of being attached, removed, and re-attached to the electronic device.

13. The folding stand (100) of claim 10, wherein the device supporting platform (110), the base platform (120), the foldable connector (130), the first supporting arm (150), and the second supporting arm (160) are each constructed from a planar rigid material.

14. The folding stand (100) of claim 13, wherein the planar rigid material is a metal or plastic material.

15. The folding stand (100) of claim 10, wherein the hinges (141-147) comprise a flexible material or hinged plates.

16. The folding stand (100) of claim 15, wherein the flexible material is a fabric, leather, rubber, or plastic material.

17. The folding stand (100) of claim 10, wherein the device supporting platform (110), the base platform (120), the foldable connector (130), the first supporting arm (150), and the second supporting arm (160) are each constructed from a planar rigid material, wherein the device supporting platform (110), the base platform (120), the foldable connector (130), the first supporting arm (150), and the second supporting arm (160) are connected to each other by a continuous flexible material covering the planar rigid materials, wherein the flexible material forms the hinges (141-147).

18. A method of positioning an electronic device (10) in an upright orientation, comprising:
a. providing the adjustable folding stand (100) of claim 10;
b. attaching the device supporting platform (110) to the underside surface (15) of the electronic device; and
c. pivotably moving the folding stand (100) into one of two positions based on a desired angle in the upright orientation:
i. the first folded configuration for supporting the electronic device (10) in the first upright orientation having a first angle (θ1) between the base platform (120) and the underside surface (15) of the electronic device; or
ii. the second folded configuration for supporting the electronic device (10) in a second upright orientation having a second angle (θ2) between the base platform (120) and the underside surface (15) of the electronic device, wherein 82 is less than 81.

19. The method of claim 18, wherein the electronic device (10) is a tablet or laptop.

20. The method of claim 18, wherein attaching the device supporting platform (110) to the underside surface (15) of the electronic device comprises adhering a device backing (170), which is fixedly attached to the device supporting platform (110), to the underside surface (15) of the electronic device.
